(19) United States
(12) Patent Application Publication
(10) Pub. No.: US 2026/0017510 A1
(43) Pub. Date: Jan. 15, 2026

(54) FINE-TUNING AI MODELS FROM DATA SELECTION

(71) Applicant: Salesforce, Inc., San Francisco, CA (US)

(72) Inventors: Daryl Martis, New York City, NY (US); Rahul Aggarwal, Milpitas, CA (US)

(73) Assignee: Salesforce, Inc., San Francisco, CA (US)

(21) Appl. No.: 18/772,106

(22) Filed: Jul. 12, 2024

(51) Int. Cl. G06N 3/08; G06F 18/2431

(52) U.S. Cl. CPC G06N 3/08; G06F 18/2431

(57) ABSTRACT

Fine-tuning AI models is described. According to some aspects, a set of one or more data objects are selected. Based on the selection, a set of one or more of a plurality of categories is selected. Also, one of a number of pre-trained AI models is selected based on the set of categories and implicit input. In addition, one of a number of fine-tuning methods is selected. The selected set of categories identify a selected subset of categorized data items in the selected set of data objects. The selected AI model is fine-tuned using the selected fine-tuning method and a version of the selected subset of categorized data items.

### TECHNICAL FIELD

One or more implementations relate to the field of artificial intelligence (AI) models; and more specifically, to the fine-tuning of AI models.

### DESCRIPTION OF THE RELATED ART

Fine-tuning is a technique where a pre-trained AI model (e.g., a larger language model (LLM)) is further trained on a smaller, domain-specific data set, allowing the model to adapt to the specific language and context of the domain. This improves its performance on domain-specific tasks (e.g., medical, legal, financial, or technical texts where language usage significantly differs from general language data; etc.).

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1A is a block diagram illustrating a system for fine-tuning AI models according to some example implementations.

FIG. 1B is a table illustrating example AI model selections and fine-tuning methods based on combinations of explicit and implicit input according to some example implementations.

FIG. 2A is a flow diagram illustrating a method for fine-tuning AI models according to some example implementations.

FIG. 2B is a flow diagram illustrating additional operations for fine-tuning AI models according to some example implementations.

FIG. 3A is a block diagram illustrating a first GUI element according to some example implementations.

FIG. 3B is a block diagram illustrating a second GUI element according to some example implementations.

FIG. 3C is a block diagram illustrating a third GUI element according to some example implementations.

FIG. 3D is a block diagram illustrating a fourth GUI element according to some example implementations.

FIG. 3E is a block diagram illustrating a fifth GUI element according to some example implementations.

FIG. 4A is a block diagram illustrating an electronic device according to some example implementations.

FIG. 4B is a block diagram of a deployment environment according to some example implementations.

### DETAILED DESCRIPTION

The following description describes implementations for fine-tuning AI models. In some implementations, a model management service is a solution to fine-tuning in view of the growing number of large language models (LLMs) that vary in terms of, for example, cost-efficiency, specialization, performance, linguistic context, language proficiency, country/cultural context, etc. Different categories of data may benefit from processing with distinct LLMs and fine-tuning strategies.

### Block Diagrams

### Exemplary Implementation(s)

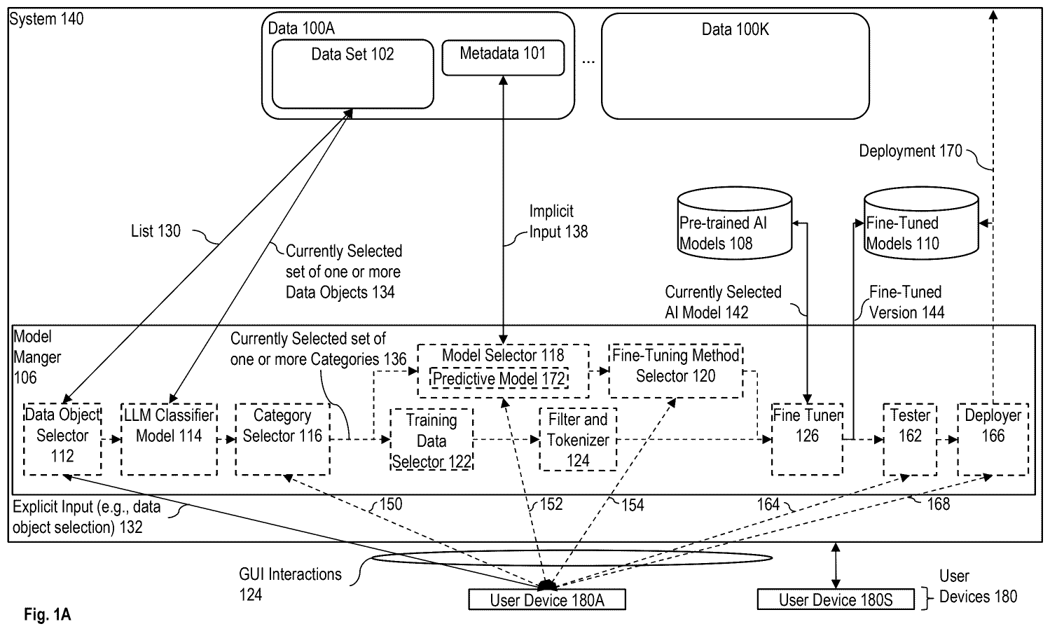

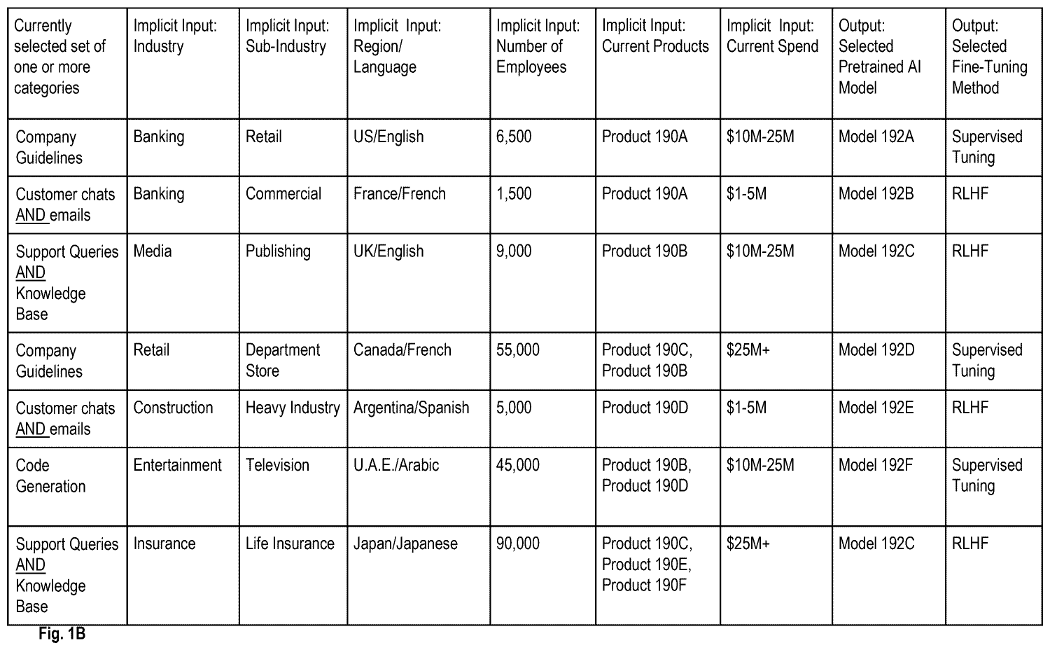

FIG. 1A is a block diagram illustrating a system for fine-tuning AI models according to some example implementations. FIG. 1A shows system 140 with which user devices 180, such as user device 180A to user device 180S, communicate as described later herein. System 140 includes model manager 106 to provide the model management service. Model manager 106 is configured to manage the generation of fine-tuned models 110 from the pre-trained AI models 108. While in FIG. 1A shows user device 180A interacting with model manager 106 via GUI interactions 128, other implementations may additionally or alternatively support other types of interaction(s) (e.g., text, commands, etc.) and/or others of user devices 180 interacting with model manager 106.

System 140 stores (or at least has access to) data associated with different organizations (shown as data 100A to data 100K that are respectively associated with different organizations). For instance, data 100A may be associated with a particular organization, and a user is using user device 180A on behalf of that organization to interact with model manager 106, which in response is accessing data 100A. An organization typically includes a group of users with access to at least some of the same data/functionality with the same or similar privileges/permissions. Organizations may be different entities (e.g., different companies, different departments/divisions of a company, and/or other types of entities), and some or all these entities may be vendors that sell or otherwise provide products and/or services to their customers.

Data 100A includes: 1) metadata 101; and 2) data set 102. By way of example, data set 102 may include one or more data objects, each data object may include multiple data items (e.g., a data object may be a table, and the data items be rows of that table; a data object may be a folder of documents, and the data items be documents in that folder; etc.).

Responsive to explicit input 132 and based on that explicit input (e.g., indicating a currently selected set of one or more data objects 134 in the data set 102), model manager 106:1) selects, as a currently selected set, one or more of a number of different categories based on which of a number of different categories the data items in the currently selected set of data objects were assigned; 2) selects as training data those of the data items determined to belong to the currently selected set of one or more of the categories; 3) accesses implicit input 138 from data 100A (e.g., from metadata 101); 4) automatically selects one of the pre-trained AI models 108 and one of a plurality of fine-tuning methods, wherein the selection of one of the pre-trained AI models 108 is based on the currently selected set of categories and the implicit input; and 5) generates a fine-tuned version 144 of the currently selected pre-trained AI model 142 using the currently selected fine-tuning method and a version of the training data (e.g., the raw training data; a filtered version of the training data; a tokenized version of the training data; a filtered and tokenized version of the training data, etc.).

The categories represent labels, tags, and/or other ways of identifying attributes (e.g., content, topic, domain, language, etc.) of the data items being categorized. As described in more detail later herein, the assignment of the categories to the data items may occur at different times and/or in different ways in different implementations. The categories assigned to the data items may be referred to as data item level categories. Different data items in a given one of the data objects may be classified as belonging to the same or different ones of the categories. While in some implementations a data item may be assigned only one of the categories, in other implementations a data item may be assigned one or more categories.

This approach is advantageous in that it eliminates the need for the user to understand the benefits/drawbacks of the different pre-trained AI models 108, the benefits/drawbacks of using different ones of the fine-tuning methods to fine-tune the different ones of the pre-trained AI models 108, and the benefits/drawbacks of using different subsets of data items with the different combinations of the pre-trained AI models 108 and the fine-tuning methods. Instead, this approach uses: 1) explicit input that is more readily understandable to the user, such as a selection of a set of one or more data objects; and 2) implicit input that is already available to system 140.

In many situations, this approach improves the operation of the electronic device(s) (reduces processing/compute, storage, and time) as compared to a more manual approach that requires the user to manually select one the pretrained AI model and one of the fine-tuning methods. Specifically, use of a fine-tuned version that was generated based on a less optimal selection(s) typically ends up being less efficient (e.g., consuming more processing/compute, storage, power, and time, as well as generating more heat) as compared to a fine-tuned version with more optimal selection(s); and since fine-tuning is relatively resource intensive (e.g., consumes a relatively large amount of processing/compute, storage, power, and/o time, as well as generates a relatively large amount of heat), generating a replacement fine-tuned version with more optimal selection(s) is relatively expensive. Thus, in situations where the more manual approach results in less optimal selection(s) for fine-tuning, the resulting fine-tuned versions: 1) may require more resources to generate results than a model fine-tuned with more optimal selection(s); 2) typically lead to users submitting more prompts to get the desired results than a model fine-tuned with more optimal selection(s); 3) typically lead to more effort being spent to fine-tune (e.g., use of more training data, additional rounds of fine-tuning, etc.) than when fine-tuning a model with more optimal selection(s); and/or 4) may lead to the generation of new fine-tuned versions to replace less performant fine-tuned versions. Thus, there is a: 1) first factor reflecting the resources required by the described approach (to access implicit data, make the automatic selections of the pre-trained AI model/fine-tuning method, etc.) as compared to the more manual approach; and 2) a second factor reflecting the resources consumed as a result of less optimal selection(s) made via the more manual approach as compared to more optimal selection(s) made with the described approach. When the first factor is less than the second factor, the performance of the implementing electronic device(s) is improved.

Also, classifying, according to the number of categories, the data items in the currently selected set of one or more data objects facilitates the selection of the data items to use for training; and this improves the operation of the electronic device(s) (reduces processing/compute, storage, and time) as compared to a more manual approach that requires the user to manually select a subset of the data items. Specifically, the manual selection of data involves user(s) accessing, sometimes repeatedly, and manipulation of data to determine which to include in the data items to use for the fine tuning. Often, a copy of the data items is stored during this selection process. Further, selection of a less optimal set of data items leads to the issues described above regarding the less optimal selections of the pretrained AI model and fine-tuning method. Thus, there is a: 1) third factor reflecting the resources required by the described approach (to classify the data items in the currently selected set of data objects) as compared to the more manual approach; and 2) a fourth factor reflecting the resources consumed to manually select the data items. When the third factor is less than the fourth factor, the performance of the implementing electronic device(s) is improved.

The first and third factors and the second and fourth factors may be combined. In other words, even if the first or third factor is greater than or equal to the second or fourth factor, when the first plus third factors are less than the second plus fourth factors, the performance of the implementing electronic device(s) is improved.

Further, depending on the scenario, the described approach improves the operation of the electronic device(s) (reduces processing/compute, storage, and time) as compared to an approach that classifies all the data items/data objects in the data set prior to any fine tuning. Specifically, in an approach that classifies all the data items/data objects in the data set prior to any fine tuning, resources such as processing/compute, storage, and time are required to perform the initial classification and maintain/update the categories as the data items/data objects are updated. In contrast, in some implementations of the described approach, only the data items in data object(s) selected for use in fine-tuning (as opposed to all data items/data objects in the data set) are classified. Thus, such implementations: 1) avoid expending the processing/compute, storage, and time required to classify the data items in data objects that are not selected for use in fine-tuning; and 2) can choose whether and for how long to maintain/update the categories once the data items in a data object have been classified (e.g., some such implementations may discard the result of the classifications immediately, discard the results after a period of time during which the data object has not be selected again for use in fine-tuning, discard the results based on an amount of available storage space (e.g., using a least recently used algorithm to decide which data items and/or data objects to keep), etc.).

In addition, the user experience may be improved by the described approach because it enables the use of a more simplified graphical user interface (GUI) as compared to the more manual approach. The more manual approach leaves users to navigate a number of GUI elements with potentially many options (e.g., shown via a drop-down list, or in some cases a scrolling drop down list) to choose an optimal model and to choose a fine-tuning method, as well as select the necessary data for fine-tuning their chosen pretrained AI model and fine tuning method. In contrast, the described approach allows for a selection at the data object level, and in response automatically selects data items from those selected data object to use as training data; one of the pre-trained AI model, one of the fine-tuning method, and fine-tunes the selected pre-trained AI model using the selected data items. Thus, a user need not make selections at the data item level. For instance, in some implementations, since the data items in the selected data object(s) are/were classified according to the categories, the selection of a set of one or more of the categories assigned to these data items may be used to select from the data items those to use as training data. By way of more specific example, in some implementations, if a single one of a number of data objects in a data set is selected, and if data item in the single data object belongs to one of two categories, then: a) the more prevalent of the two categories is selected (in some implementations, automatically); and b) only those of the data items in the single data object that belong to the selected category are selected from for use as the training data. Thus, implementations may use a single GUI element that allows for the selection of one or more of the data objects in the data set, and then perform the rest of the operations (e.g., classification, selection of categories based on the categories of the data items in the selected data object(s), selection of a pretrained-AI model, selection of fine tuning method, and the fine tuning) automatically (rather than using additional GUI elements to allow for the selections for some or all of the rest of the operations). However, it may be desirable to have more GUI elements (e.g., some additional GUI elements are described below).

### More Detailed Exemplary Implementation(s)

By way of example, FIG. 1A shows model manager 106 including data object selector 112, LLM classifier model 114, category selector 116, model selector 118, fine-tuning method selector 120, training data selector 122, and fine tuner 126. In some implementations, model manager 106 optionally includes filter and tokenizer 124, tester 162, deployer 166, or any combination thereof. While FIG. 1A shows model manager 106 including a particular number of components, a particular distribution of tasks to those components, and a particular order to those tasks, other implementations may include a different number of components, different distribution of tasks, and/or a different order to those tasks (e.g., rather than having model selector 118 and/or fine-tuning method selector 120 on a parallel path with training data selector 122 and filter and tokenizer 124, having them on a serial path; splitting filter and tokenizer into separate components, and optionally swapping their order).

Data object selector 112 is to receive a list 130 of data objects in data set 102, cause a representation of that list to be presented via GUI interactions 128 on user device 180A on behalf of an organization with which the data set 102 is associated, and receive as explicit input 132 a selection of one or more of the data objects as a currently selected set of one or more data objects 134.

LLM classifier model 114 is to classify, according to several categories, data items stored in the currently selected set of one or more data objects 134. While in some implementations the LLM classifier model 114 is part of system 140, other implementations may use a different type of model and/or use a model outside of system 140. As discussed above, different implementations may classify the data items at different times. For example: a) some implementations may, responsive to the selection of the set of data objects, always classify all of the data items in those selected data object(s); b) some implementations may save prior categorizations (at least for a time) of the data items, and thus check to see whether and which previously saved categorizations may be reused (e.g., whether a categorization is stored, when that categorization was last updated, etc.) vs those data items that need to be classified; etc.

Category selector 116 is to select, from the categor(ies) assigned the data items in the currently selected set or one or more data objects 134, a currently selected set of one or more categories 136. For example, the set of categories may be selected based on the prevalence by category of the data items stored in the currently selected set of data objects. Different implementations may measure prevalence at different levels of granularity, in different ways, and/or at different times.

For example, with regard to granularity, some implementations measure prevalence across the data items in the currently selected set of data objects, while alternative implementations use a different approach (e.g., measure prevalence based on the data items in each of the currently selected set of data objects separately, and one category may be for each data object; measure prevalence based on the data items in each of the currently selected set of data objects separately, and combine the result with prevalence across the data items in the currently selected set of data objects, to determine the currently selected set of one or more categories; etc.).

With regard to different ways of measuring prevalence, the selection may be based on a ratio and/or a threshold. For instance, some implementations measure the ratio of data items classified in the different ones of the data item level categories (e.g., if 80% of the data items were categorized as company guidelines and 20% as customer chats, the training category selection may be company guidelines); and some such implementations will include an indication of the ratio (for instance, in the preceding example, the selected category may be company guidelines with the indication being 80%) which may be referred to as a confidence indicator. In some such implementations, if the ratio does not indicate that one of the categories exceeds a threshold, then a training category selection is not made (e.g., if 50% of the data items were categorized as company guidelines, 30% as customer chats, and 20% as knowledge base, and the threshold is 70%, a category will not be selected based on just the data items in that data object). In other such implementations, the training data category selection may result in the selection of more than one of the categories based on a threshold. For example, if 50% of the data items were categorized as company guidelines, 30% as customer chats, and 20% as knowledge base, and the threshold is 35%, the result of the training category selection may be both company guidelines and customer chats.

Finally, different implementations may make the category selection at different times. As a first example, some implementations (like that shown in FIG. 1A) make the selection based on the categories assigned to the data items in the selected data object(s), and this is done after all the data items have been categorized by LLM classifier model 114. As a second example, some implementations (not shown) make the category selection based on the categories assigned to a sample of the data items (e.g., a subset of the data items in a data object, where the ratio of the categories among of the data items in the subset is expected to be representative of the ratio of the categories across all of the data items in the data object); and this may be done once the categories of the sample data items are known (e.g., previously stored categorizations, the result of classifications responsive to the explicit input, or a combination), thus avoiding any delay that may result from waiting for the classification process to complete.

As a third example, some implementations (not shown) also assign categories at the data object level and make the selection of the set of one or more categories based on any already stored data object level categories assigned the currently selected set of data object(s); thus avoiding any delay that may result from waiting for the classification process of all the data items to complete. In some implementations of this third example, data object level categories are: 1) assigned only if the confidence level regarding the data level categorization is relatively high (e.g., the ratio of data items belonging to the category exceed a threshold, such as 80%); and 2) discarded if the number of changes (e.g., additions, edits, or deletions) to the data items in that data object are below a threshold. In addition to avoiding delays due to a need to classify all of the data items in the currently selected set of one or more object(s), some implementations use the data level categorization to avoid storing (or for less time) the data item level categories. For example, if a first data object was selected for a first fine-tuning model, and as a result the data items in that first data object were classified, and if the number of the data items classified as belonging to a first category exceed a threshold, then: a) the first data object may be assigned the first category as a data object level category, and this assignment stored at least for a time; b) the data item level categories may be discarded; and c) a subsequent selection of the first data object may base, at least in part, the currently selected set of one or more categories on the stored data object level category, and then use that set of categor(ies) to start the process of selecting a pre-trained AI model while the data items in the first data objects are classified again. Again referring to this third example, different ones of these implementations may assign the data object level categories in different ways. For instance, the assignment may be based on the ratio of the data items classified in the different ones of the data item level categories (e.g., if 80% of the data items were categorized as company guidelines and 20% as customer chats, the data object may be classified as belonging to company guidelines), and some such implementations will include an indication of the ratio (for instance, in the preceding example, the data object may be classified as belonging to company guidelines with the indication being 80%) which may be referred to as a confidence indicator. In some such implementations, a data object is assigned a catch all category (e.g., unknown or mixed) if the ratio does not indicate that one of the categories exceeds a threshold (e.g., if 50% of the data items were categorized as company guidelines, 30% as customer chats, and 20% as knowledge base, and the threshold is 70%, the data object may be classified as belonging to the catch all category). In other such implementations, a data object may be assigned more than one of the categories, with an indication of the ratio for each. For example, if 50% of the data items were categorized as company guidelines, 30% as customer chats, and 20% as knowledge base, the data object may be classified as belonging to all three of these categories at the determined percentages. In some such implementations, the ratio for a given category much exceed a threshold to be included in the list of categories (e.g., if 50% of the data items were categorized as company guidelines, 30% as customer chats, and 20% as knowledge base, and the threshold is 35%, the data object may be classified as belonging to company guidelines and customer chats at the determined percentages).

Model selector 118 is to select one of the pre-trained AI models 108 as a currently selected pre-trained AI model 142 based on the currently selected set of one or more categories 136 and implicit input 138. By way of example, metadata 101 provides additional information about data 100A, data items in the data 100A, and/or the organization with which the data 100A is associated. By way of more specific example, metadata 101 may include source(s) of the data/data items, format(s) of the data/data items, content in the data/data items, size(s) of the data/data items, date(s) related to the data items, author(s) of the data items, owner(s) of the data/data items, the language(s) of the organization, product(s)/service(s) of the organization, industr(ies) of the organization, sub-industr(ies) of the organization, an amount of revenue of the organization, geographic region(s) for the organization, a language(s) identified as being needed by the organization, a number of employees of the organization, a set of one or more of a plurality of products/services (e.g., that are offered as part of system 140 or a larger platform) that have been licensed by the organization, a current spend by the organization with the organization that operates system 140, or a number of licenses the organization has with another organization that operates system 140. While in some implementations metadata 101 is part of system 140, in other implementations some or all the metadata 101 may be stored outside of system 140. While in some implementations implicit input 138 represents information based on (taken directly from and/or inferred from) metadata 101, implicit input 138 may additionally or alternatively be based on information from one or more other sources (e.g., the internet).

While in some implementations implicit input 138 includes an industry of the organization (e.g., finance, banking, marketing, media, retail, construction, entertainment, insurance, etc.), a geographic region for the organization, a language, or any combination thereof, other implementations includes some, all, more, and/or different information (e.g., a combination of a set of one or more industries of the organization, a set of one or more geographic regions relevant to the organization, and a set of one or more languages identified as being needed by the organization; that combination plus, a set of one or more sub-industries of the organization, (e.g., retail, commercial, publishing, department store, heavy industry, television, life insurance, etc.) and a number of employees of the organization, or any combination thereof; that combination plus a set of one or more of a plurality of products/services that have been licensed by the organization and a current spend by the organization with another organization that operates system 140, or any combination thereof).

In some implementations, model selector 118 uses a predictive model 172 to predict the most suitable one of pre-trained AI models 108 based on the currently selected set of one or more categories 136 and the implicit input 138. In some implementations, predictive model 172 may be a classification model that uses a decision tree, a random forest, or a K-means clustering algorithm. Predictive model 172 may be trained using historical data that includes records of previous selections of pre-trained AI models 108. While some implementations use a predictive model, other implementations may use a different technique (e.g., a lookup in a table).

Fine-tuning method selector 120 is to select one of a plurality of fine-tuning methods as a currently selected fine-tuning method based at least on the currently selected pre-trained AI model 142. The plurality of fine-tuning methods may include different techniques or algorithms for adjusting the parameters or weights of an AI model. The plurality of fine-tuning methods may include supervised fine-tuning, unsupervised fine-tuning, reinforcement learning-based fine-tuning (RLHF), adversarial fine-tuning, or any combination thereof. In some implementations, for at least one of the pre-trained AI models, the selection of the fine-tuning method may be based on additional information. For instance, if more than one of the fine-tuning methods may be used in conjunction with the currently selected AI model, then in some implementations the selection of the fine-tuning method may also be based on some of the currently selected set of one or more categories 136 and/or some of the implicit information. For instance, a cost-benefit/tradeoff analysis may be used to select the most appropriate fine-tuning method for the organization based on the currently selected AI model, the currently selected set of one or more categories 136, and the implicit input 138. For example, if the currently selected AI model is a pre-trained AI model that is trained on a large corpus of financial texts in French and has a high performance on summarization tasks, a fine-tuning method that requires less data and less computation (e.g., reinforcement learning) may be chosen. While FIG. 1A illustrates that model selector 118 and fine-tuning method selector 120 may be implemented separately, in other implementations they are merged and the same predictive model 172 provides a combination of the currently selected pre-trained AI model 142 and the selected fine-tuning method.

Training data selector 122 is to select those of the data items determined to belong to the currently selected set of one or more categories. As previously described, the data items were previously classified according to the categories. Since each category and combination of categories represents a respective subset of the data items, the currently selected set of categories identifies a currently selected subset of the data items. Thus, if a data object has data items in two different categories, but only a first of those categories is in the currently selected set of categories, then only those data items in the first data object determined to belong to the first category are selected. In some implementations, training data selector 122 may also select a quantity of the data items to include in the training data (e.g., if there are X data items determined to belong to the first category, and X is greater than a threshold Y, then only Y of those data items are selected for the training data).

Similar to the above description about different implementation measuring prevalence in different ways (e.g., across the data items in the currently selected set of data objects, per data object, etc.), training data selector 122 may apply the currently selected set of one or more categories differently. For example, assume that: 1) the currently selected set of data objects includes a first and second data objects; 2) the measure of prevalence is performed separately on the first and second data objects; and 3) a first and second category is selected respectively for the first and second data objects. In this examples, different implementations may select as the training data either: 1) the data items that are in the first and second data object and that assigned either category; 2) the data items in the first data object assigned the first category, and the data items in the second data object assigned the second category; etc. Thus, the selection of the categor(ies) by category selector 116 may be across the data object(s) or per data object; and where that category selection is per data object, the selection of the training data by training data selector 122 may be across the data object(s) or per data object.

Filter and tokenizer 124 is to filter and tokenize the selected training data to generate a tokenized and filtered version of the selected training data. Filter and tokenizer 124 may apply one or more filters to remove or modify data items or parts of data items that are not suitable or relevant for the currently selected pre-trained AI model 142 and/or the currently selected fine-tuning method. For example, filter and tokenizer 124 may: 1) apply a privacy filter, which filters data deemed sensitive or private (e.g., personally identifiable information) by removing it or replacing it; 2) remove data items that are irrelevant, duplicates, redundant, noisy, incomplete, or any combination thereof; and/or 3) modify data items. Filter and tokenizer 124 may further tokenize data items by splitting them into smaller units, such as words, characters, subwords, symbols, or any combination thereof. The tokenizing may also include applying any preprocessing techniques, such as stemming, lemmatization, normalization, punctuation removal, masking, hashing, encoding, or any combination thereof. In some implementations, after tokenization (or as part of tokenization), grouping of words can be done to identify specific phrases or entities that are relevant to the task.

Fine tuner 126 is configured to generate a fine-tuned version 144 of the currently selected pre-trained AI model 142 through training using the currently selected fine-tuning method and a version of the selected training data. For example, the version may be the selected training data as is, a filtered version of the selected training data, a tokenized version of the selected training data, a filtered and tokenized version of the selected training data. Fine tuner 126 may adjust the parameters or weights of the currently selected pre-trained AI model 142 using an optimization algorithm, such as stochastic gradient descent, Adam, RMSprop, or any combination thereof. Fine tuner 126 may use a loss function, such as cross-entropy, mean squared error, Kullback-Leibler divergence, or any combination thereof to measure the difference between the output of the fine-tuned version 144 and the desired output for a given input.

The data items in the data objects of data set 102 may include several types of data, such as text, audio, video, image, or any combination thereof, that are relevant to the organization. Different implementations may use different categories, such as: 1) different types or classes of data; 2) topics, such as business, financial data, entertainment, news, sports, politics, entertainment, etc.; 3) formats, such as text, image, audio, video, or any combination thereof; 4) attributes, such as length, style, tone, sentiment, or any combination thereof; 5) themes; 6) domains; 7) genres; 8) styles; 9) tones; 10) sentiments; 11) document types, such as instruction documents, manuals, guidelines (e.g., company guidelines), customer service cases, chats (e.g., customer service chats), knowledge base, emails, company press releases, design documents, support documents, training documents, programming code (e.g., code repository), other documents, archives, etc.; or any combination thereof.

LLM classifier model 114 may use natural language understanding techniques to assign one or more categories to each data item in the categorized data set. LLM classifier model 114 may be a pre-trained AI model that has been trained on a large-scale natural language corpus, such as Wikipedia, Common Crawl, or any combination thereof. With some prompt tuning, the LLM classifier can also be instructed to ignore certain types of documents from selection.

Pre-trained AI models 108 may have different costs associated with their use, such as licensing fees, cloud computing fees, or any combination thereof. Pre-trained AI models 108 may have different capabilities, such as text generation, text summarization, sentiment analysis, question answering, image classification, image captioning, face recognition, speech synthesis, speech recognition, or any combination thereof. More specifically, pre-trained AI models 108 may include BERT (e.g., ROBERTa, AraBERT, VisualBert, M-BERT, etc.), GPT (e.g., GPT-3, GPT-4, GPT-4V, etc.), T5 (e.g., Large, 3B, 11B, etc.), Mistral (e.g., Mistral 7B, Mistral Large, etc.), XLM-R, CLIP, DALL-E (e.g., DALL-E 2, DALL-E 3, etc.), Gemini (e.g., Gemini 1.0 Ultra, Gemini 1.5, etc.), Claude (e.g., Claude 2, Claude 3, etc.), Cohere (e.g. Command), LLaMa (e.g., LLaMa 2, LLaMa 3, etc.), or any combination thereof. While pre-trained AI models 108 are shown as being part of system 140, one, some or all may be accessed from external sources, such as online repositories, marketplaces, libraries, or any combination thereof.

A fine-tuning method represents a machine learning technique that adapts a pre-trained AI model to a specific task, goal, domain, language(s), applications, etc., using a smaller amount of data than the original training data. A fine-tuning method may include, for example, supervised fine-tuning, which uses labeled data to fine-tune a pre-trained AI model for a specific task, such as classification, regression, summarization, question answering, or any combination thereof. A fine-tuning method may also include, for example, reinforcement learning-based fine-tuning (RLHF), which uses a reward function to fine-tune a pre-trained AI model for a specific goal, such as generating text that matches a desired style, tone, sentiment, or any combination thereof. A fine-tuning method may also include, for example, unsupervised fine-tuning, which uses unlabeled data to fine-tune a pre-trained AI model.

Fine-tuned models 110 represent a plurality of AI models that have been fine-tuned using one or more of the pre-trained AI models 108. As compared to the pre-trained AI models 108, fine-tuned models 110 may have improved performance and/or accuracy for specific tasks, goals, domains, languages, applications, etc. Thus, fine-tuned models 110 are typically tailored to the needs and/or preferences of an organization that uses system 140.

Tester 162 is configured to test fine-tuned version 144 of currently selected pre-trained AI model 142 using test data. Tester 162 may take a percentage (e.g., 20%) of the raw training data and run it through a set of one or more different quality metric tests (Coherence, factuality, instruction following, etc.) on both the selected pre-trained AI model and the fine-tuned version. The results of these may be shown to a user on a GUI in a side-by-side comparison. This typically happens before the fine-tuned model is deployed by Deployer 166. In some embodiments, the quality metrics include: 1) BLEU score, which measures the similarity between the output of fine-tuned version 144 and a human-generated reference text; 2) coherence score, which measures the logical consistency and clarity of the output of fine-tuned version 144; 3) completeness score, which measures the extent to which the output of fine-tuned version 144 covers all the relevant information from the input; 4) conciseness score, which measures the brevity and succinctness of the output of fine-tuned version 144; 5) factuality score, which measures the correctness and veracity of the output of fine-tuned version 144; and/or 6) instruction following score, which measures the ability of fine-tuned version 144 to follow a given instruction or command. Some implementations additionally or alternatively include an overall score, which measures the aggregate or average performance of fine-tuned version 144 based on one or more of the above-described metrics. Tester 162 may use various algorithms or techniques to generate the set of metrics, such as evaluation, validation, verification, comparison, benchmarking, or any combination thereof.

Deployer 166 is configured to deploy fine-tuned version 144 of currently selected pre-trained AI model 142 responsive to receiving an instruction to deploy or activate from user device 180A. Deploying represents a process of enabling fine-tuned version 144 to perform one or more tasks (such as generating text, summarizing text, answering questions, recognizing images, detecting objects, transcribing speech, translating speech, or any combination thereof), which may include transferring or copying fine-tuned version 144 to one or more other electronic device(s) as indicated by deployment 170.

GUI interactions 128 may include: 1) menus, buttons, sliders, checkboxes, radio buttons, text boxes, dropdown lists, icons, images, graphs, charts, tables, or any combination thereof; 2) status indicator(s) that show the progress or the completion of the fine-tuning process of AI models; 3) indicators that show what is currently selected in a given list of options; and 4) navigation elements that allow the user of user device 180A to move between different steps or stages of the fine-tuning process of AI models, such as cancel, next, previous, save, accept, or any combination thereof. While FIG. 1A shows the GUI interactions 128 including the provision of the explicit input 132, it also shows that some implementations support other GUI interactions at one or more other stages of the process (e.g., GUI interactions 150, 152, 154, 164, and 168 respectively with category selector 116, model selector 118, fine-tuning method selector 120, tester 162, and deployer 166; see example GUI elements later herein).

### Exemplary Categories

As described above, the data items are classified according to several categories. In some implementations, these categories are predetermined and include two or more of the following: company guidelines, customer chats, emails, support queries, knowledge base, and code generation (such as a distributed version control system (e.g., an internal GIT repository (also known as a GIT repo)

Exemplary Selection Mechanism and/or Training Data for Predictive Model 172

FIG. 1B is a table illustrating example AI model selections and fine-tuning methods based on combinations of the currently selected set of one or more categories and implicit input according to some example implementations. The table in FIG. 1B includes: 1) one column for the currently selected set of one or more categories; 2) six columns for implicit inputs; and 3) two result columns respectively for the selected pretrained AI model and the selected fine-tuning method.

The fifth of the implicit input columns is for “Current Products,” and the cells in the rows of that column contain a product 190A; the product 190A; a product 190B; a combination of the product 190B and 190C; a product D, a combination of product 190B and 190D; and a combination of product C, a product E, and a product F. By way of example, products 190A-F may respectively be a financial analytics service, a Customer Call Center Service, a marketing service, a customer data platform, an industries service (a service specifically tailored to a particular industry), a media service, etc. The first of the result columns is for “Selected Pretrained AI Model,” and the cells in the rows of that column contain a Model 192A; the Model 192B; a Model 192C; a Model 192D; a Model 192E; a Model 192F; and the Model 192C. By way of example, models 192A-F may respectively be a banker LLM, Mistral 7B, Claude 3, Google Gemini 1.5 Pro, Cohere Command, and LLaMa 3.

Different ones of the currently selected set of categories and implicit inputs may have different influences on the selections of the pretrained AI model and fine-tuning method. For example:

In some implementations, inclusion of the currently selected set of categories may influence the selection of the pre-trained AI model because one or a subset of the pre-trained AI models may be better suited for certain ones of the categories because those model(s) were pre-trained on data of that type.

In some implementations, inclusion of the currently selected set of categories may influence the selection of the fine-tuning method because some categories are more likely to have feedback data which is more suitable for RLHF than for the supervised learning.

In some implementations, inclusion of the industry in the implicit information may influence the selection of the pre-trained AI model because one or a subset of the pre-trained AI models may have been trained using a large corpus of data pertaining to the industry of the organization.

In some implementations, inclusion of the sub-industry in the implicit information may influence the selection of the pre-trained AI model because one or a subset of the pre-trained AI models may have been trained using a large corpus of data pertaining to a sub-industry of the organization.

In some implementations, inclusion of the region and/or language in the implicit information may influence the selection of the pre-trained AI model because one or a subset of the pre-trained AI models may have been trained using a large corpus of data pertaining the culture of a certain region and/or that uses a certain language.

In some implementations, inclusion of the current products in the implicit information may influence the selection of the pre-trained AI model because the current products may pertain to a certain service/industry/subindustry and one or a subset of the pre-trained AI models may have been trained using a large corpus of data pertaining to that service, industry or sub-industry. For example, the selection of the pre-trained AI model may be influenced where the industry of the organization is not the financial industry, but the organization is purchasing one or more financial products/services.

In some implementations, inclusion of the number of employees in the implicit information provides an estimate of how many people the model will be serving (e.g., a higher number of AI model responses results in higher costs). Thus, this may influence: 1) the choice between an open-source model and a commercial model; 2) the size of the pre-trained AI model (e.g., number of parameters); etc. In some implementations, the cost preference may also influence: 1) the amount of data to use for fine-tuning; 2) the type of computational resources to use to perform the fine-tuning; 3) the estimated time required for the fine-tuning; etc. For example, a relatively large number of employees may influence the selection of a pre-trained AI model that is open source; in contrast, a relatively small number of employees may influence the selection of a pre-trained AI model that is not open source.

In some implementations, inclusion of the current spend in the implicit information may provide an estimate of a cost preference (a higher spend suggests that a higher cost pre-trained AI model may be acceptable or even preferred). Thus, such a cost preference type input may influence the selection of the pre-trained AI model in a similar manner as the number of employees.

The rows of the table in FIG. 1B provide specific examples of explicit and implicit information, and following is how that information influences the selection process in some implementations:
Row 1: The optimal selection may be the combination of a pre-trained AI model that was trained on a large corpus of financial texts (a “Banker LLM”) (major influences being the explicit input of Company Guidelines category and implicit input of Banking Industry; while a minor influence may be that the organization's current products include a financial analytics product) and supervised fine-tuning (a major influence being the Company Guidelines category because typically the less complex fine tuning method of Supervised Fine-tuning is sufficient).
Row 2: The optimal selection may be an open-source Mistal 7B model (major influences being the company chats and emails category, the implicit input of banking industry, France being the region, French being the language; and a minor influences could also be the commercial sub-industry as well as the current spend since model cost preference was not explicitly stated) and RLHF fine-tuning (major influences being the selection of the Mistal 7B model, the category being the customer chats and emails (which benefits from using positive and negative examples of customer chat transcripts to fine-tune, and hence RLHF as the fine-tuning method)).
Row 3: The optimal selection may be a non-open sourced Claude 3 model (major influences being the Support Queries and Knowledge Base categories, UK as the region, English as the language; and minor influences could also be the publishing sub-industry and the 9000 employees) and RLHF fine tuning method (major influences being the selection of Claude 3 model and Support Queries and Knowledge Base categories (which benefits from using positive and negative examples of customer chat transcripts to fine-tune, and hence RLHF as the fine-tuning method)).
Row 4: The optimal selection may be the Gemini 1.5 Pro model (major influences being the Company Guidelines category, the organization's language being French, and the organization's industry being retail; a minor influence being the number of employees since it is a proxy to how many times the model will be called) and supervised fine-tuning (a major influence being the Company Guidelines category because typically the less complex fine tuning method of Supervised Fine-tuning is sufficient).
Row 5: The optimal selection may be the non-open sourced Cohere Command model (major influences being the Company Chats and Emails category, Argentina as the region, Spanish as the language, and a Medium cost preference (indicating that a non-open sourced model would be acceptable)) and RLHF (a major influence being the Company Chats and Emails category (for which the RLHF method works well); minor influences may include that a current product is an industries services product).
Row 6: The optimal selection may be an open sourced LLaMa 3 model (major influences being the Code Generation category, U.A.E. as the region, and Arabic as the language (while the computer code may be generated in English, the method of communicating with the model will be in Arabic); while minor influences could include the number of employees since that is an indication of how many calls to the fine-tuned model will be made) and supervised tuning (a major influence being the Code Generation category because less complex fine-tuning capabilities are typically sufficient).
Row 7: The optimal selection may be the Claude 3 model (major influences being the Support Queries and Knowledge Base categories, Japan as the region, Japanese as the language; and minor influences could also be the current products being a marketing service, an industries service, and/or a media service) and RLHF (a major influence being the Support Queries and Knowledge Base categories (which benefits from positive and negative examples for RLHF).

### Flow Diagrams

The below figures illustrating flow diagrams sometimes refer to the figure(s) illustrating block diagrams, and vice versa. Whether or not explicitly described, the alternative implementations discussed with reference to the above figures illustrating block diagrams also apply to the implementations discussed with reference to the below figures illustrating flow diagrams, and vice versa. At the same time, the scope of this description includes implementations, other than those discussed with reference to the block diagrams, for performing the flow diagrams, and vice versa.

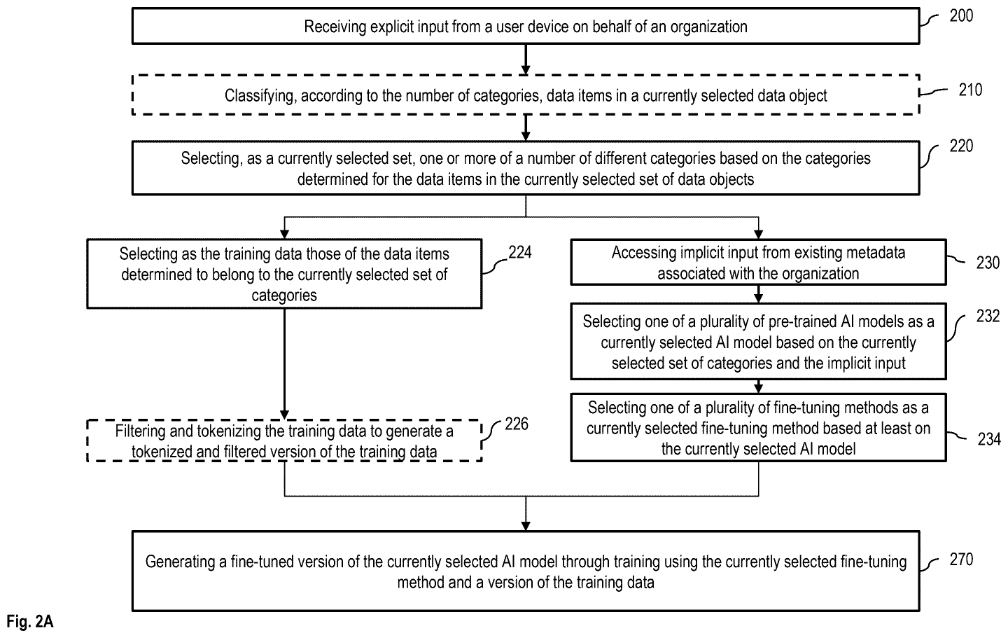

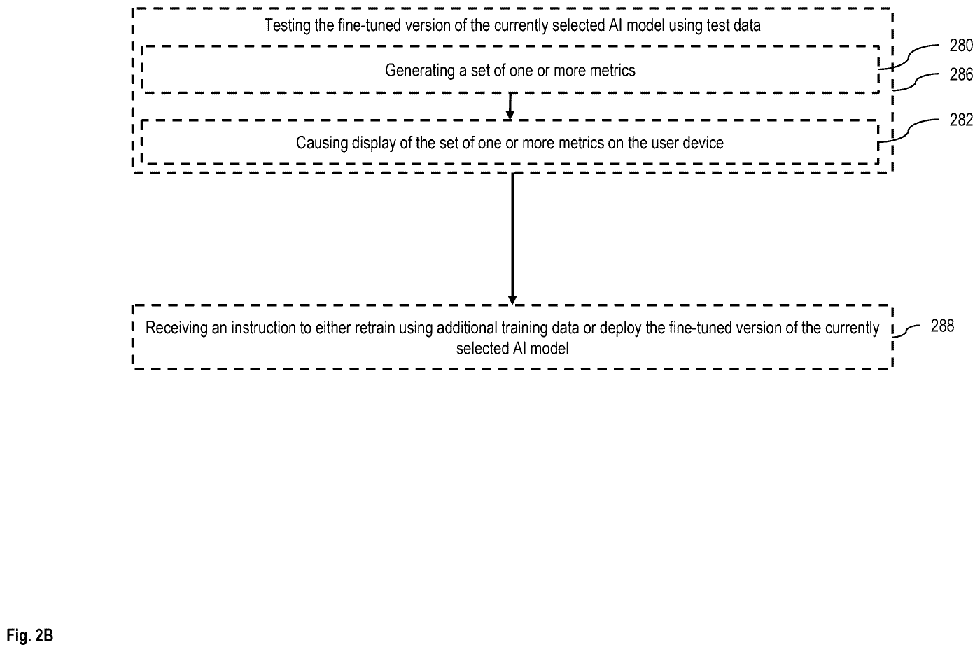

FIG. 2A is a flow diagram illustrating a method for fine-tuning AI models according to some example implementations. In some implementations the method may be performed by model manager 106 as part of a model management service.

Block 200 illustrates the receiving of explicit input from a user device on behalf of an organization. As described above, the explicit input includes a currently selected set of one or more of the data objects in a data set associated with an organization. Block 200 may be performed by data object selector 112 and/or make use of the first GUI element discussed below.

Block 210 illustrates classifying, according to a number of categories, data items in the currently selected set of one or more data objects. In some implementations, block 220 may be performed by LLM classifier model 114. Block 210 is dashed to represent that, as described above, the classification of the data items according to the categories may be performed at different times, in different ways, and at different levels of granularity in different implementations.

Block 220 illustrates selecting, as a currently selected set, one or more of the number of different categories based on the categories determined for the data items in the currently selected set of one or more data objects. In some implementations, block 220 may be performed by category selector 116 and/or make use of the second GUI element discussed below. As illustrated, control flows from block 220 to blocks 224 and 230 to reflect they may be done in parallel. However, as discussed above, blocks 224, 226, 230, 232, and 234 may be performed serially.

Block 224 illustrates selecting as the training data those of the data items determined to belong to the currently selected set of one or more categories. Thus, as described above, the currently selected set of one or more categories is used to identify a selected subset of the data items in the data set associated with the organization. In some implementations, block 224 may be performed by training data selector 122.

Block 226 illustrates filtering and tokenizing the selected subset of data items to generate a tokenized and filtered version of the selected subset of data items. In some implementations, block 226 may be performed by the filter and tokenizer 124. Block 226 is dashed to represent it is optional.

Block 230 illustrates accessing implicit input from existing metadata associated with the organization. As described above, the implicit input may include a variety of different types of information.

Block 232 illustrates selecting one of a plurality of pre-trained AI models as a currently selected AI model based on the currently selected set of one or more categories and the implicit input. In some implementations, blocks 230 and 232 may be performed by model selector 118 (with block 232 being performed by model selector 118 using predictive model 172) and/or make use of the third GUI element discussed below.

Block 234 illustrates selecting one of a plurality of fine-tuning methods as a currently selected fine-tuning method based at least on the currently selected AI model. As described above, in some implementations: 1) the fine-tuning methods may include supervised fine-tuning, unsupervised fine-tuning, reinforcement learning-based fine-tuning, human-in-the-loop fine-tuning, or any combination thereof; and/or 2) the selection of one of the fine-tuning methods may be based on additional information. In some implementations, block 234 may be performed by fine-tuning method selector 120 and/or make use of the fourth GUI element discussed below. While in some implementations blocks 232 and 234 may be performed respectively by model selector 118 and fine-tuning method selector 120, in other implementations these operations are combined (e.g., both the AI model and the fine-tuning method are selected at the same time using predictive model 172).

Block 270 illustrates the generating of a fine-tuned version of the currently selected AI model through training using the currently selected fine-tuning method and a version of the selected subset of data items. In some implementations, the fine-tuning may be performed by the fine tuner 126. A described above, the version may be the selected subset of data items as is (block 226 is not performed), a filtered version of the selected subset of data items (block 226 only performs filtering), a tokenized version of the selected subset of data items (block 260 only performs tokenizing), a filtered and tokenized version of the selected subset of data items.

FIG. 2B is a flow diagram illustrating additional operations for fine-tuning AI models according to some example implementations. In some implementations these operations may also be performed by model manager 106 as part of a model management service. In some implementations, one, more, or all these operations may be performed directly after the operations in FIG. 2A.

Block 286 illustrates the testing of the fine-tuned version of the currently selected AI model. In some implementations, this includes: 1) generating a set of one or more metrics that measure the fine-tuned version of the currently selected AI model (block 280) (which may include use of a validation data set, which may be a part of the data set 102 that is not used for the fine-tuning and/or an external data set), where the set of one or more metrics may include any of the metrics described above, such as accuracy, precision, recall, F1-score, BLEU score, ROUGE score, METEOR score, coherence score, conciseness score, factuality score, instruction following score, or any combination thereof; and 2) causing the display of the set of one or more metrics on the user device (bock 282). In some implementations, block 286 may be performed by tester 162 and/or make use of the fifth GUI element discussed below. With reference to FIG. 1A, user device 180A may present the set of one or more metrics in a graphical user interface (GUI) element, such as a dashboard, a chart, a table, or any other suitable format. The GUI element may allow the user to compare the performance or quality of the fine-tuned version of the currently selected AI model with the performance or quality of the pre-trained AI model or other fine-tuned AI models. The GUI element may also allow the user to provide feedback or input on the set of one or more metrics, such as by adjusting a threshold, selecting a preferred metric, or modifying a weight or a parameter. Tester 162 may send its results to user device 180A, the predictive model 172, and/or another component of the system 140.

Block 288 illustrates receiving an instruction to either retrain the fine-tuned version of the currently selected AI model using additional training data or deploy the fine-tuned version of the currently selected AI model. In some implementations, block 286 is performed by deployer 166. In some implementations, the instruction may be provided by: 1) a user of user device 180A, and be based on the user's satisfaction or dissatisfaction with the set of one or more metrics, the test results, or both; and/or 2) a different decision maker (e.g., a model, such as the predictive model 172) when the set of one or more metrics and/or the result of the testing satisfies a predefined criterion or a condition. If the instruction is to retrain the fine-tuned version of the currently selected AI model, the flow may return to: 1) block 200 or 220 to select a different set of one or more categories; 2) block 224 to select additional data belonging to the previously selected set of categories; 3) block 226 to filter and tokenize the selected subset using different criteria or methods; 4) block 232 to select a different pretrained AI model; and/or 5) block 234 to select a different fine-tuning method. If the instruction is to deploy the fine-tuned version of the currently selected AI model, the fine-tuned version of the currently selected AI model is enabled to perform one or more tasks (such as generating text, summarizing text, answering questions, recognizing images, detecting objects, transcribing speech, translating speech, or any combination thereof), which may include transferring or copying fine-tuned version 144 to one or more other electronic device(s).

As used herein, the phrase “currently selected set of one or more” refers to implementations that are capable of selecting one or more, as well as implementations that are capable of selecting only one. For instance, some implementations may allow for: 1) only one data object to be selected, but one or more categories to be selected; 2) one or more data objects to be selected, but only one category to be selected; or 3) one or more data objects to be selected, and one or more categories to be selected.

### Exemplary GUI Interfaces

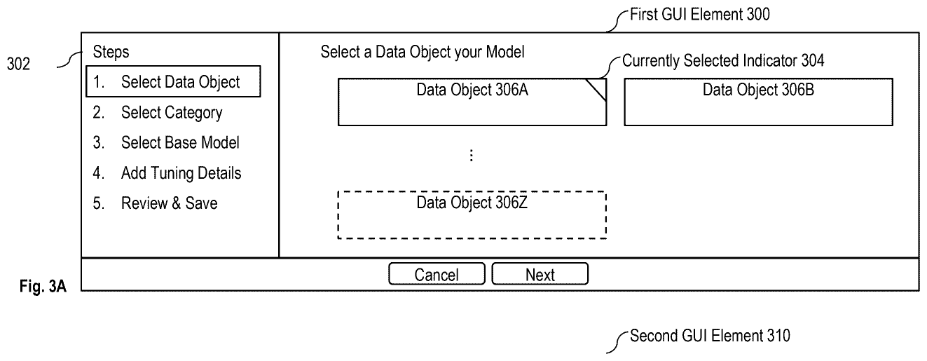

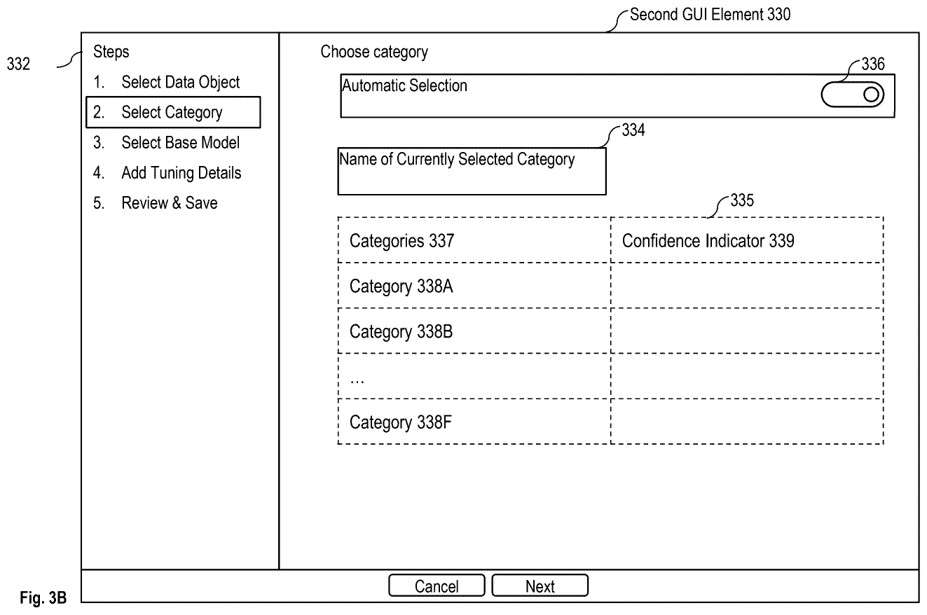

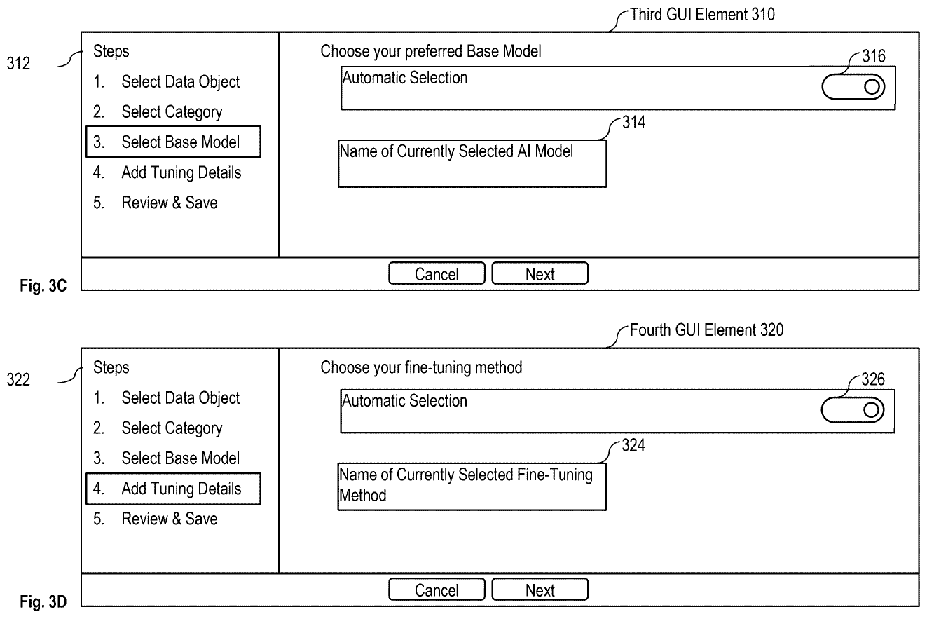

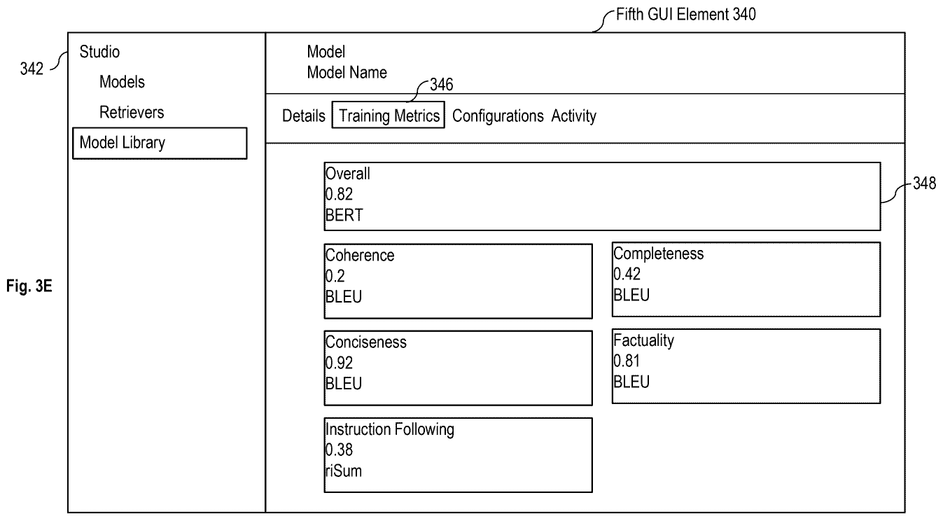

FIG. 3A is a block diagram illustrating a first GUI element according to some example implementations. FIG. 3A shows a first GUI element 300 that may be displayed on user device 180A to enable a user to select one or more of a plurality of data objects 306, such as data object 306A, 306B, etc. The user may select one of the data objects 306 by clicking or tapping on it. The currently selected data object(s) may be indicated by a currently selected indicator 304, such as a check mark, a highlight, or a different color. The first GUI element 300 may include an area 302 that shows: 1) steps involved in the fine-tuning process, such as “Select Data Object”, “Select Category,” “Select Base Model”, “Add Tuning Details”, and “Review & Save;” and 2) an indicator of the current step in the fine-tuning process, such as a box around the “Select Data Object.” The first GUI element 300 may further include a navigation bar that allows the user to abort or move to the next step, such as by clicking or tapping on “Cancel” or “Next” button.

As previously described, implementations may use a single GUI element (e.g., first GUI element 300) that allows for the selection of one or more of the data objects in the data set, and then perform the rest of the operations (e.g., classification, selection of categories based on the categories of the data items in the selected data object(s), selection of a pretrained-AI model, selection of fine tuning method, and the fine tuning) automatically (rather than using additional GUI elements to allow for the display of the automatic selections, or even to modify the automatic selection (change, add, remove), for some or all of the rest of the operations). However, it may be desirable to have more GUI elements, such as one of more of those described below.

FIG. 3B is a block diagram illustrating a second GUI element according to some example implementations. FIG. 3B shows a second GUI element 330 that includes the name(s) of the currently selected category (ies) at 334. The second GUI element 330 may include: 1) an area 332, which is like the area 302, but this time includes an indicator of the current step being “Select Category;” and 2) a navigation bar that allows the user to abort or accept the automatic selection, such as by clicking or tapping on “Cancel” or “Next” buttons. Also, the second GUI element 330 also optionally includes information regarding the categories determined for at least some of the data items in the currently selected set of data objects, as well as the data objects and/or indications of confidence regarding those categories for selection (e.g., for the currently selected set of data objects, the previously described ratio reflecting the percentage of data items across the data object(s) that were classified as belonging to that category; for each data object in the currently selected set of data objects, the previously described ratio reflecting the percentage of data items in that data object that were classified as belonging to that category). For instance, FIG. 3D shows table 335 with: 1) a categories 337 column under which are respectively listed category 338A to category 338F; and 2) a confidence indicator 339 column under which are listed respective confidence indicators (not shown) for the categories. Additional or alternatively, implementations may include information regarding the currently selected set of data objects (e.g., show the categories relative to the currently selected set of data objects, which of the currently selected set of data objects contributed to which of the categories, etc.).

By way of example, assume: 1) a first data object with the data items stored therein having all (100%) been classified as company guidelines 100; 2) a second data object with the data items stored therein having been classified 60% company guidelines, 30% HR Guidelines, and 10% vendor procurement data; 3) a third data object with the data items stored therein having been classified 80% Customer chats and 20% knowledge base; 4) a fourth data object with the data items stored therein having been classified as 90% emails and 10% other; 5) a fifth data object with the data items stored therein having been classified as 40% customer chats, 40% emails, and 20% other. In a first scenario, assuming that only the first data object is selected, then the currently selected set of categories will be just company guidelines and all of the data items may be selected for the training data. In a second scenario, assuming that only the second data object is selected, the currently selected set of categories will be just company guidelines and only those of the data items determined to be categorized as company guidelines may be selected for the training data. In a third scenario, assuming that both the third and fourth data objects are selected, the currently selected set of categories may be both customer chats and emails, and only those of the data items determined to be categorized as customer chats and emails may be selected for the training data. In a fourth scenario, assuming that only the first data object is selected and a category inclusion threshold is set to 35%, the currently selected set of categories may be both customer chats and emails, and only those of the data items determined to be categorized as customer chats and emails may be selected for the training data.

In some implementations, a user can review the selection and confidence indicators, and choose to add and/or remove data objects and/or categories. The second GUI element 330 may further include a toggle button 336 for enabling or disabling automatic selection, which may allow the user to let the system 140 choose the categor(ies) without any manual intervention. While the figure illustrates an ability for the user to enable or disable the automatic selection of one of the set of categories, in other implementations (e.g., this particular aspect is not automatically selectable; one cannot disable automatic selection but the other aspects of the GUI element are still used; one cannot disable automatic selection and this GUI element).

FIG. 3C is a block diagram illustrating a third GUI element according to some example implementations. FIG. 3C shows a third GUI element 310 that may be displayed on the user device 180A after the currently selected set of one or more categories has been determined. The third GUI element 310 may include: 1) an area 312, which is like the area 302, but this time includes an indicator of the current step being “Select Base Model;” and 2) a navigation bar that allows the user to abort or accept the automatic selection, such as by clicking or tapping on “Cancel” or “Next” buttons. The third GUI element 310 at 314 displays the name of the currently selected AI model, which is the one of the pre-trained AI models 108 selected by model selector 118 based on the currently selected set of one or more categories and the implicit input 138. The third GUI element 310 may further include a toggle button 316 for enabling or disabling automatic selection, which may allow the user to let the system 140 choose the pretrained model without any manual intervention. While the figure illustrates an ability for the user to enable or disable the automatic selection of one of the pretrained AI models, in other implementations (e.g., this particular aspect is not automatically selectable; one cannot disable automatic selection but the other aspects of the GUI element are still used; one cannot disable automatic selection and this GUI element).

FIG. 3D is a block diagram illustrating a fourth GUI element according to some example implementations. FIG. 3C shows a fourth GUI element 320 that may be displayed on user device 180A after the selection of one of the plurality of pretrained AI models. The fourth GUI element 320 may include: 1) an area 322, which is like the area 312, but this time includes an indicator of the current step being “Add Tuning Details;” 2) a navigation bar that allows the user to abort or accept the automatic selection, such as by clicking or tapping on “Cancel” or “Next” buttons; and 3) a toggle button 326, which is like toggle button 316, which may allow the user to let the system 140 choose the fine-tuning method without any manual intervention. The fourth GUI element 320 displays at 324 the name of the currently selected fine-tuning method. While the figure illustrates an ability for the user to enable or disable the automatic selection of one of the fine-tuning method, in other implementations (e.g., this particular aspect is not automatically selectable; one cannot disable automatic selection but the other aspects of the GUI element are still used; one cannot disable automatic selection and this GUI element).

FIG. 3E is a block diagram illustrating a fifth GUI element according to some example implementations. FIG. 3E shows a fifth GUI element 340 that may be displayed once the fine-tuning has been performed. The fifth GUI element 340 includes: 1) an area 342 that allows a user to navigate between different types of information (e.g., models, retrievers, and model library); 2) an area that shows details of the fine-tuned version of the currently selected AI model, such as a name associated with the fine-tuned version; 3) an area that allows a user to navigate between different types of information (e.g., Details, Training Metrics, Configurations, and Activity) pertaining to the fine-tuned version, and a box 346 around Training Metrics to reflect it is currently active; and 4) an area that displays metrics (e.g., generated by tester 162) pertaining to the fine-tuned version of the currently selected AI model. As previously described, the metrics may include, for example, a coherence score, a completeness score, a conciseness score, a factuality score, and an instruction following score, each measured using a suitable evaluation metric such as BLEU or riSum. The fifth GUI element 340 may further display at 348 an overall score in terms of BERT that reflects the quality of the fine-tuned version 144 based on the metrics as previously described.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

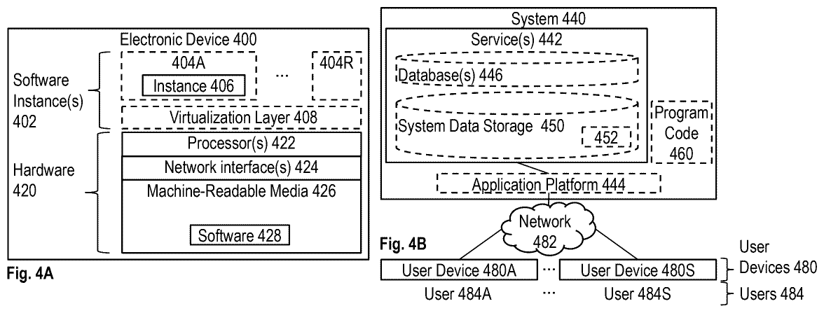

FIG. 4A is a block diagram illustrating an electronic device 400 according to some example implementations. FIG. 4A includes hardware 420 comprising a set of one or more processor(s) 422, a set of one or more network interfaces 424 (wireless and/or wired), and machine-readable media 426 having stored therein software 428 (which includes instructions executable by the set of one or more processor(s) 422). The machine-readable media 426 may include non-transitory and/or transitory machine-readable media. Each of the previously described clients and the model management service may be implemented in one or more of electronic devices 400. In one implementation: 1) each of the clients is implemented in a separate one of the electronic device 400 (e.g., in end user devices where the software 428 represents the software to implement clients to interface directly and/or indirectly with the model management service (e.g., software 428 represents a web browser, a native client, a portal, a command-line interface, and/or an application programming interface (API) based upon protocols such as Simple Object Access Protocol (SOAP), Representational State Transfer (REST), etc.)); 2) the model management service is implemented in a separate set of one or more of electronic device 400 (e.g., a set of one or more server devices where the software 428 represents the software to implement the model management service); and 3) in operation, the electronic devices implementing the clients and the model management service would be communicatively coupled (e.g., by a network) and would establish between them (or through one or more other layers and/or or other services) connections for submitting instructions (e.g., GUI interactions 128) to the model management service and returning GUI elements to the clients. Other configurations of electronic devices may be used in other implementations (e.g., an implementation in which the client and the model management service are implemented on a single one of electronic device 400).

During operation, an instance of software 428 (illustrated as instance 406 and referred to as a software instance; and in the more specific case of an application, as an application instance) is executed. In electronic devices that use compute virtualization, the set of one or more processor(s) 422 typically execute software to instantiate a virtualization layer 408 and a set of one or more software containers, shown as software container 404A to software container 404R (e.g., with operating system-level virtualization, the virtualization layer 408 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 408 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of software 428 is executed within software container 404A on the virtualization layer 408. In electronic devices where compute virtualization is not used, instance 406 on top of a host operating system is executed on the “bare metal” electronic device 400. Instances of software 428, as well as the virtualization layer 408 and the software containers if implemented, are collectively referred to as software instance(s) 402.

Alternative implementations of an electronic device may have numerous variations from that described above. For example, customized hardware and/or accelerators might also be used in an electronic device.

### Example Environment

FIG. 4B is a block diagram of a deployment environment according to some example implementations. System 440 includes hardware (e.g., a set of one or more server devices) and software to provide service(s) 442, including the model management service. In some implementations the system 440 is in one or more datacenter(s). These datacenter(s) may be: 1) first party datacenter(s), which are datacenter(s) owned and/or operated by the same entity that provides and/or operates some or all of the software that provides the service(s) 442; and/or 2) third-party datacenter(s), which are datacenter(s) owned and/or operated by one or more different entities than the entity that provides the service(s) 442 (e.g., the different entities may host some or all of the software provided and/or operated by the entity that provides the service(s) 442). For example, third-party datacenters may be owned and/or operated by entities providing public cloud services (e.g., Amazon Web Services® service by Amazon.com, Inc., Google Cloud System™ service by Google LLC, Azure® service by Microsoft Corporation).

The system 440 is coupled to user devices 480 (shown as user device 480A to user device 480S) over a network 482. The service(s) 442 may be on-demand services that are made available to users 484 (shown as user 484A to user 484S) working for one or more entities other than the entity which owns and/or operates the on-demand services (those users sometimes referred to as outside users) so that those entities need not be concerned with building and/or maintaining a system, but instead may make use of the service(s) 442 when needed (e.g., when needed by the users). The service(s) 442 may communicate with each other and/or with one or more of the user devices 480 via one or more APIs (e.g., a REST API). In some implementations, user devices 480 are operated by the users 484, and each may be operated as a client device and/or a server device. In some implementations, one or more of the user devices 480 are separate ones of the electronic device 400 or include one or more features of the electronic device 400.

In some implementations, the system 440 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of System as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 440 is a multi-tenant cloud computing architecture supporting multiple services, such as one or more of the following types of services: Model Management Service, Customer relationship management (CRM); Customer Call Center, Configure, price, quote (CPQ); Business process modeling (BPM); Customer support; Marketing; Customer Data Platform (performs data unification and identity resolution); External data connectivity; Productivity; Media; Database-as-a-Service; Data-as-a-Service (DAAS or DaaS); System-as-a-service (PAAS or PaaS); Infrastructure-as-a-Service (IAAS or IaaS) (e.g., virtual machines, servers, and/or storage); Analytics; Community; Internet-of-Things (IoT); Industry-specific (e.g., a financial analytics service); Artificial intelligence (AI); Application marketplace (“app store”); Data modeling; Security; and Identity and access management (IAM).

For example, system 440 may include an application platform 444 that enables PAAS for creating, managing, and executing one or more applications developed by the provider of the application platform 444, users accessing the system 440 via one or more of the user devices 480, or third-party application developers accessing the system 440 via one or more of user devices 480.

In some implementations, one or more of the service(s) 442 may use one or more database(s) 446 and/or system data storage 450 (which stores system data 452). In certain implementations, the system 440 includes a set of one or more servers that are running on server electronic devices and that are configured to handle requests for any authorized user associated with any tenant (there is no server affinity for a user and/or tenant to a specific server). The user devices 480 communicate with the server(s) of system 440 to request and update tenant-level data and system-level data hosted by system 440, and in response the system 440 (e.g., one or more servers in system 440) automatically may generate one or more Structured Query Language (SQL) statements (e.g., one or more SQL queries) that are designed to access the desired information from the database(s) 446 and/or system data storage 450.

In some implementations, the service(s) 442 are implemented using virtual applications dynamically created at run time responsive to queries from the user devices 480 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 460 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, application platform 444 includes an application setup mechanism that supports application developers' creation and management of applications, which may be saved as metadata by save routines. Invocations to such applications, including the model management service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 482 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 440 and the user devices 480.

Each of the user devices 480 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 440. For example, the user interface device can be used to access data and applications hosted by system 440, and to perform searches on stored data, and otherwise allow one or more of users 484 to interact with various GUI pages that may be presented to the one or more of users 484. The user devices 480 may communicate with system 440 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 480 may include an HTTP client, commonly referred to as a “browser,” for sending and receiving HTTP messages to and from server(s) of system 440, thus allowing one or more of the users 484 to access, process and view information, pages and applications available from system 440 over network 482.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other. While the flow diagrams in the figures show a particular order of operations

performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A system comprising:
a non-transitory machine-readable storage medium that provides instructions, which when executed, provide a model manager comprising:
a large language model (LLM) classifier to classify, according to a plurality of categories, data items stored in a currently selected set of one or more data objects, the currently selected set of data objects having been received as explicit input from a user device on behalf of an organization, the currently selected set of data objects having been selected from a plurality of data objects associated with the organization, wherein the plurality of objects store respective pluralities of data items;
a category selector to select a set of one or more of the plurality of categories as a currently selected set of categories based on prevalence by category of the data items stored in the currently selected set of data objects;
a model selector to select one of a plurality of pre-trained AI models as a currently selected AI model based on the currently selected set of categories and implicit input, the implicit input having been accessed from existing metadata associated with the organization, and wherein the implicit input includes an industry of the organization, a geographic region for the organization, a language, or any combination thereof;
a fine-tuning method selector to select one of a plurality of fine-tuning methods as a currently selected fine-tuning method based at least on the currently selected AI model;
a training data selector to select those of the data items determined to belong to the currently selected set of categories; and
a fine tuner to generate a fine-tuned version of the currently selected AI model through training using the currently selected fine-tuning method and a version of the training data.

2. The system of claim 1, wherein when the data items stored in the currently selected set of one or more data objects are all classified as belonging to a single one of the plurality of categories, the category selector selects that single one as the currently selected set of categories.

3. The system of claim 1, wherein when the data items stored in the currently selected set of data objects are classified as belonging to more than one of the plurality of categories, the category selector selects as the currently selected set of categories a single one of the plurality of categories based on a ratio of the data items having been classified as belonging to that single one exceeding a threshold.

4. The system of claim 1, wherein the plurality of plurality of categories include: company guidelines; customer chats and emails; support queries and knowledge base; code generation; or any combination thereof.

5. The system of claim 1, wherein the implicit input includes a combination of the industry of the organization, a set of one or more geographic regions, and a set of one or more languages identified as being needed for the organization.

6. The system of claim 5, wherein the implicit input also includes a set of one or more sub-industries of the organization, a number of employees of the organization, or any combination thereof.

7. The system of claim 6, wherein the implicit input also includes a set of one or more of a plurality of products that have been licensed by the organization, a current spend by the organization with a second organization that operates the system, or any combination thereof.

8. The system of claim 1, wherein the model manager further comprises:
a filter and tokenizer to filter and tokenize the training data to generate the version of the training data;
a tester to test the fine-tuned version of the currently selected AI model, generate a set of one or more metrics, and cause display of the set of one or more metrics on the user device; and
a deployer to receive an instruction from the user device to either retrain using additional training data or deploy the fine-tuned version of the currently selected AI model.

9. The system of claim 1, wherein the model manager is configurable to cause a representation of the plurality of data objects to be displayed on the user device.

10. The system of claim 1, wherein the model manager is configurable to cause:
the currently selected set of categories to be displayed on the user device with a first graphical user interface GUI element that allows the user of the user device to accept the currently selected set of categories;
a name of the currently selected AI model to be displayed on the user device with a second graphical user interface (GUI) element that allows a user of the user device to accept the currently selected AI model; and
a name of the currently selected fine-tuning method to be displayed on the user device with a third GUI element that allows the user of the user device to accept the currently selected fine-tuning method.

11. A computer implemented method for fine-tuning artificial intelligence (AI) models, the method comprising:
receiving explicit input from a user device on behalf of an organization, wherein the explicit input includes selection of one or more of a plurality of data objects as a currently selected set of data objects, wherein the plurality of objects store respective pluralities of data items;
classifying, using a large language model (LLM) classifier and according to a plurality of categories, those of the data items stored in the currently selected set of data objects;
responsive to the classifying, selecting one or more of the plurality of categories as a currently selected set of categories based on prevalence by category of the data items stored in the currently selected set of data objects;
accessing implicit input from existing metadata associated with the organization, wherein the implicit input includes an industry of the organization, a geographic region for the organization, a language, or any combination thereof;
selecting one of a plurality of pre-trained AI models as a currently selected AI model based on the currently selected set of categories and the implicit input;
selecting one of a plurality of fine-tuning methods as a currently selected fine-tuning method based at least on the currently selected AI model;
selecting as training data those of the data items determined to belong to the currently selected set of categories; and
generating a fine-tuned version of the currently selected AI model through training using the currently selected fine-tuning method and a version of the training data.

12. The method of claim 11, wherein when the data items stored in the currently selected set of one or more data objects are all classified as belonging to a single one of the plurality of categories, the selecting includes selecting a single one as the currently selected set of categories.

13. The method of claim 11, wherein when the data items stored in the currently selected set of data objects are classified as belonging to more than one of the plurality of categories, the selecting includes selecting as the currently selected set of categories a single one of the plurality of categories based on a ratio of the data items having been classified as belonging to that single one exceeding a threshold.

14. The method of claim 11, wherein the plurality of categories distinguish information of at least these types: company guidelines; customer chats and emails; support queries and knowledge base; and a code generation.

15. The method of claim 11, wherein the implicit input includes a combination of the industry of the organization, a set of one or more geographic regions, and a set of one or more languages identified as being needed for the organization.

16. The method of claim 15, wherein the implicit input also includes a set of one or more sub-industries of the organization, a number of employees of the organization, or any combination thereof.

17. The method of claim 16, wherein the implicit input also includes a set of one or more of a plurality of products that have been licensed by the organization, a current spend by the organization with a second organization, or any combination thereof.

18. The method of claim 11, further comprising:
filtering and tokenizing the training data to generate a version of the training data;
testing the fine-tuned version of the currently selected AI model, wherein the testing includes:
generating a set of one or more metrics, and
causing display of the set of one or more metrics on the user device; and
receiving an instruction from the user device to either retrain using additional training data or deploy the fine-tuned version of the currently selected AI model.

19. The method of claim 1, further comprising:
causing a representation of the plurality of data objects to be displayed on the user device.

20. The method of claim 19, further comprising:
causing the currently selected set of categories to be displayed on the user device with a first graphical user interface GUI element that allows the user of the user device to accept the currently selected set of categories;
causing a name of the currently selected AI model to be displayed on the user device with a second graphical user interface (GUI) element that allows a user of the user device to accept the currently selected AI model; and
causing a name of the currently selected fine-tuning method to be displayed on the user device with a third GUI element that allows the user of the user device to accept the currently selected fine-tuning method.
